(19) United States
(12) Patent Application Publication
(10) Pub. No.: US 2021/0186031 A1
(43) Pub. Date: Jun. 24, 2021

(54) COMPOSITIONS, METHODS, AND KITS RELATING TO OAK LEAF EXTRACT SUPPRESSION OF CITRUS HUANGLONGBING (HLB) IN CITRUS

(71) Applicants: University of Florida Research Foundation, Inc., Gainesville, FL (US); The United States of America as Represented by the Secretary of Agriculture, Washington, DC (US)

(72) Inventors: Liliana M. CANO MOGROVEJO, Fort Pierce, FL (US); Marco PITINO, Fort Pierce, FL (US); Lorenzo ROSSI, Fort Pierce, FL (US); Robert SHATTERS, Fort Pierce, FL (US)

(21) Appl. No.: 17/126,757

(22) Filed: Dec. 18, 2020

Related U.S. Application Data
(60) Provisional application No. 62/951,587, filed on Dec. 20, 2019.

(51) Int. Cl. A01N 65/28

(52) U.S. Cl. CPC A01N 65/28

(57) ABSTRACT

Disclosed herein are compositions, methods, and kits for suppression in huanglongbing (HLB) in a subject having HLB (or otherwise for treatment of symptoms of HLB in a subject in need thereof. In embodiments, compositions and methods as described herein comprise compositions relating to oak leaf extract to applied to or around citrus plants having or suspected of having HLB.

### FEDERAL SPONSORSHIP

This invention was made with government support under 58-6034-8-014 Cooperative Agreement with the United States Department of Agriculture, Agricultural Research Services. The government has certain rights in the invention.

### CROSS-REFERENCE TO RELATED APPLICATION

This application claims priority to and the benefit of U.S. Provisional Application entitled “COMPOSITIONS, METHODS, AND KITS RELATING TO OAK LEAF EXTRACT SUPPRESSION OF CITRUS HUANGLONGBING (HLB) IN CITRUS,” having Ser. No. 62/951,587, filed on Dec. 20, 2019, which is entirely incorporated herein by reference.

### BACKGROUND

Citrus huanglongbing (HLB), also known as citrus greening, is a devastating disease with high economical costs to the worldwide citrus industry. The disease is caused by three species of α-proteobacterium, “Candidatus Liberibacter asiaticus (CLas),” “Ca. L. africanus,” and “Ca. L. americanus.” CLas, the most widespread pathogen, is vectored by the Asian Citrus Psyllid (ACP) Diaphorina citri Kuwayama (Hemiptera: Psyllidae). CLas attacks all species and hybrids in the Citrus genus, and upon infection, resides in the phloem of the host causing a systemic disease and can eventually kill the tree. Once a tree is infected, it is extremely difficult to treat, and currently there is no adequate strategy for HLB management.

Currently, there is no cure for HLB, no compounds have been successful in controlling HLB, and no sustainable management practices have been established for citrus greening disease. Thus, searching for alternative citrus greening disease mitigation strategies is considered an urgent priority for a sustainable citrus industry.

Accordingly, there is a need to address the aforementioned deficiencies and inadequacies, in particular to characterize proteins transcribed and translated from the genome by the bacterium.

### SUMMARY

Described herein are compositions, kits, and methods relating to suppression of citrus huanglongbing (HLB; also referred to herein as “citrus greening disease”) in citrus plants or trees.

Described herein are compositions relating to suppression of citrus HLB or treating symptoms of HLB in a subject in need thereof otherwise. In an embodiment, described herein is an aqueous oak leaf extract composition extracted from one or more processed leaves of Quercus hemisphaerica. The composition can be extracted with water, ethanol, or methanol. In an embodiment, the composition is extracted from methanol. In an embodiment, the aqueous oak leaf extract composition is an effective amount to suppress citrus huanglongbing (HLB) in a subject.

Described herein are methods relating to suppression of citrus HLB, in particular methods for suppressing of citrus huanglongbing (HLB) in a subject in need thereof (or treatment of symptoms of HLB in a subject in need thereof). In embodiments, methods as described herein can comprise providing a composition as described herein to the subject in need thereof. In embodiments, the composition can be applied to the subject through irrigation, spray, or both. In embodiments, the composition can be applied biweekly for two months. In embodiments, the composition can be applied to the roots, the leaves, or both. In embodiments, the subject in need thereof is a citrus plant infected with HLB. In embodiments, the subject in need thereof is one of Citrus medica, Citrus maxima, Citrus sinensis, Citrus reticulata, or Citrus excels. In embodiments, the citrus plant is a Duncan grapefruit, Washington navel orange, citron mandarin, or Cleopatra mandarin. In embodiments, the citrus plant is selected from the group consisting of individuals or hybrids of: C. medica, C. aurantium, C. tangerine, C. ichangensis, C. limetta, C. unshiu, C. maxima, C. grandis, C. Paradisi, C. maxima, C. limon, C. japonica, C. glauca, C. bergamia, C. sinensis, C. reticulata, Poncirus trifoliate, or hybrids thereof. In embodiments, irrigation is to the soil of the subject. In embodiments, the spraying is to the leaves of the subject. In embodiments, the composition is an effective amount to suppress HLB in the subject in need thereof. In embodiments, the composition is present in processed oak mulch.

Described herein are kits relating to suppression of citrus HLB. In embodiments, a kit for suppressing citrus huanglongbing (HLB) in a subject in need thereof comprises a composition as described herein, or a mulch comprising a composition as described herein. In embodiments, kits as described herein further comprise an application device. In embodiments, the kits as described herein comprise a composition in an amount effective to suppress citrus huanglongbing (HLB) in the subject in need thereof.

### BRIEF DESCRIPTION OF THE DRAWINGS

Many aspects of the disclosed devices and methods can be better understood with reference to the following drawings. The components in the drawings are not necessarily to scale, emphasis instead being placed upon clearly illustrating the relevant principles. Moreover, in the drawings, like reference numerals designate corresponding parts throughout the several views.

FIG. 1 is an illustration of the time course depiction of the experimental design of an embodiment of the present disclosure. Citrus plants were allowed to grow for 2 years. Then, they were graft-inoculated using CLas-infected buds and infection was confirmed by quantitative PCR (qPCR). After 1 year from the infection, CLas infected plants were treated with oak extract and water for 2 months using spray and drench applications. After treatments, plants were left to recover for 4 months and analyzed for physiological parameters and CLas titer.

FIG. 2A-2D are photographs depicting a comparison of citrus leaves and whole plants treated with oak extract and water control. FIG. 2A: Leaves treated with oak extract did not show the typical chlorotic symptoms and yellow spots. FIG. 2B: Control leaves showed severe chlorosis and typical HLB symptoms referred to as blotchy mottle. FIG. 2C: CLas-infected citrus plants showing typical light green leaves and reduction of root structure, FIG. 2D: Citrus plants treated with oak extract showing darker green leaves and increased root structure.

FIGS. 3A-3C are graphs showing the effect of oak extract and water treatments on the concentrations of macronutrients in citrus roots, stems, and leaves. FIG. 3A: Nitrogen (%). FIG. 3B: Phosphorous (g/mg) and FIG. 3C: Potassium. Means followed by asterisk are statistically significantly different *(p<0.05) **(p<0.005). Error bars represent the standard deviation (n=5).

FIGS. 4A-4D. Chlorophyll content (FIG. 4A), Electrolyte leakage (FIG. 4B) and stomatal conductance (FIGS. 4C and 4D) of citrus leaves treated with oak extract or water only. Chlorophyll content (FIG. 4A) was measured at the end of the experiment. Electrolyte leakage (FIG. 4B) was measured using middle leaves at the indicated time points. Means followed by asterisk are statistically significantly different (p<0.05). Error bars represent the standard deviation (n=3). Stomatal conductance was performed on plants treated with water (FIG. 4C) or with oak extract (FIG. 4D). Measurements were taken on upper (T), middle (M) and bottom (B) leaves. Numbers on the figure indicated the mean of the value for T, M and B leaves followed by the standard deviation. Each value was then averaged per plant (TMB) as indicated in the bottom.

FIGS. 5A-5D are graphs of showing quantification of starch-related gene transcripts by qRT-PCR and starch content in leaf tissues. FIG. 5A: beta-amylases; FIG. 5B: granule bond starch synthase (GBSSI); FIG. 5C: cell death associated protein (LDAP); and FIG. 5D: relative soluble starch content in leaf tissues. Asterisks indicate statistically significant differences between control and treated plants; bars indicate standard deviation; the results were analyzed for significant difference with Student's t-test.

FIGS. 6A and 6B are HPLC-UV chromatograms of oak leaf extracts. FIG. 6A is a HPLC-UV chromatogram of the aqueous oak leaf extract. FIG. 6B is HPLC-UV chromatogram of the aqueous methanol oak leaf extract.

FIG. 7 is an illustration of starch accumulation and chlorosis induced by CLas. Starch accumulates in the chloroplast since it fails to be degraded, possibly breaking down thylakoid membranes and thus causing chlorosis. Eventually, the overabundance of starch granules causes the chloroplast membrane to rupture chlorosis appears. Oak treatment reduces the CLas titer and the transitory starch metabolism is restored, the starch granules following the normal degradation.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, organic chemistry, microbiology, molecular biology, plant pathology, horticulture, botany, bacteriology, and the like.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmosphere. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Definitions

Unless otherwise defined, all technical and scientific terms used herein have the same meaning as commonly understood by one of ordinary skill in the art of molecular biology, medicinal chemistry, arboricultural, and/or organic chemistry. Although methods and materials similar or equivalent to those described herein can be used in the practice or testing of the present disclosure, suitable methods and materials are described herein.

As used in the specification and the appended claims, the singular forms “a,” “an,” and “the” may include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

“Subject” or “subject in need thereof” as used herein denotes an infected citrus plant or a citrus plant susceptible or otherwise at risk for bacterial infection of diseases as described herein. In certain aspects, the bacterial infection can be an infection by the Candidatus Liberibacter asiaticus bacteria (also referred to herein as CLas, Las, C. Las, Ca. L. asiaticus, and so forth). The bacterial infection can be Citrus Huanglongbing (HLB) disease (also referred to herein as citrus greening disease). Plants can be citrus plants. Citrus plants as described herein can be one or more of Citrus sinensis, Citrus reticulata, Citrus paradise, and Citrus excels. In embodiments according to the present disclosure, a citrus plant is a Duncan grapefruit, Washington navel orange, citron mandarin, or Cleopatra mandarin. In embodiment, the subject in need thereof is a plant that produces citrus fruits, such as mandarin orange, pummelo and citron. In embodiments, the citrus plants are citron (C. medica), pomelo (C. maxima), mandarin (C. reticulata), or hybrids thereof.

“Sample” as used herein, sample can refer to an infected subject or part of the subject at risk for bacterial infection, for example, part of a leaf or root of a plant or a component thereof.

As used herein, “control” is an alternative subject or sample used in an experiment for comparison purposes and included to minimize or distinguish the effect of variables other than an independent variable.

As used herein, “expression” refers to the process by which polynucleotides are transcribed into RNA transcripts. In the context of mRNA and other translated RNA species, “expression” also refers to the process or processes by which the transcribed RNA is subsequently translated into peptides, polypeptides, or proteins.

As used herein, “nucleic acid” and “polynucleotide” generally refer to a string of at least two base-sugar-phosphate combinations and refers to, among others, single- and double-stranded DNA, DNA that is a mixture of single-and double-stranded regions, single- and double-stranded RNA, and RNA that is mixture of single- and double-stranded regions, hybrid molecules comprising DNA and RNA that may be single-stranded or, more typically, double-stranded or a mixture of single- and double-stranded regions. In addition, polynucleotide as used herein refers to triple-stranded regions comprising RNA or DNA or both RNA and DNA. The strands in such regions may be from the same molecule or from different molecules. The regions may include all of one or more of the molecules, but more typically involve only a region of some of the molecules. One of the molecules of a triple-helical region often is an oligonucleotide. “Polynucleotide” and “nucleic acids” also encompasses such chemically, enzymatically or metabolically modified forms of polynucleotides, as well as the chemical forms of DNA and RNA characteristic of viruses and cells, including simple and complex cells, inter alia. For instance, the term polynucleotide includes DNAs or RNAs as described above that contain one or more modified bases. Thus, DNAs or RNAs comprising unusual bases, such as inosine, or modified bases, such as tritylated bases, to name just two examples, are polynucleotides as the term is used herein. “Polynucleotide” and “nucleic acids” also includes PNAs (peptide nucleic acids), phosphorothioates, and other variants of the phosphate backbone of native nucleic acids. Natural nucleic acids have a phosphate backbone, artificial nucleic acids may contain other types of backbones, but contain the same bases. Thus, DNAs or RNAs with backbones modified for stability or for other reasons are “nucleic acids” or “polynucleotide” as that term is intended herein.

As used herein, “deoxyribonucleic acid (DNA)” and “ribonucleic acid (RNA)” generally refer to any polyribonucleotide or polydeoxribonucleotide, which may be unmodified RNA or DNA or modified RNA or DNA. RNA may be in the form of a tRNA (transfer RNA), snRNA (small nuclear RNA), rRNA (ribosomal RNA), mRNA (messenger RNA), anti-sense RNA, RNAi (RNA interference construct), siRNA (short interfering RNA), or ribozymes.

As used herein, “nucleic acid sequence” and “oligonucleotide” also encompasses a nucleic acid and polynucleotide as defined above.

As used herein, “DNA molecule” includes nucleic acids/polynucleotides that are made of DNA.

As used herein, “wild-type” is the typical form of an organism, variety, strain, gene, protein, or characteristic as it occurs in nature, as distinguished from mutant forms that may result from selective breeding or transformation with a transgene.

As used herein, “culturing” refers to maintaining plants under conditions in which they can grow.

As used herein, “gene” refers to a hereditary unit corresponding to a sequence of DNA that occupies a specific location on a chromosome and that contains the genetic instruction for a characteristic(s) or trait(s) in an organism. As used herein, “synthetic gene” can refer to a recombinant gene comprising one or more coding sequences for a protein of interest, or a synthetically purified protein that is not naturally occurring in its purified state.

As used herein, “cDNA” refers to a DNA sequence that is complementary to a RNA transcript in a cell. It is a non-naturally occurring man-made molecule. Typically, cDNA is made in vitro by an enzyme called reverse-transcriptase using RNA transcripts as templates.

As used herein “chemical” refers to any molecule, compound, particle, or other substance that can be a substrate for an enzyme in the enzymatic pathway described herein and/or a carboxylesterase enzyme or biochemical pathway. A “chemical” can also be used to refer to a metabolite of a carboxylic ester. As such, “chemical” can refer to nucleic acids, proteins, organic compounds, inorganic compounds, metabolites etc.

As used herein, “biologic molecule,” “biomolecule,” “biological target” and the like refer to any molecule that is present in a living organism and includes without limitation, macromolecules (e.g. proteins, polysaccharides, lipids, and nucleic acids) as well as small molecules (e.g. metabolites and other products produced by a living organism).

As used herein, “regulation” refers to the control of gene or protein expression or function.

As used herein, “native” refers to the endogenous version of a molecule or compound relative to the host cell or population being described.

As described herein, the phrase “donor plant” refers to a plant or piece of a plant that is symptomatic for HLB which is grafted onto a non-HLB plant for the purposes of experimentation. The term “microorganism” used herein refers to organisms recognized in the art as “microorganisms”. Microorganisms contemplated in the present disclosure include bacteria, filamentous fungi, and yeast. Additional examples of microorganism that can be used according to the present disclosure are well known to a person of ordinary skill in the art and such embodiments are within the purview of the present disclosure.

A “label”, “detectable label,” or “detectable moiety” is a composition detectable by spectroscopic, photochemical, biochemical, immunochemical, chemical, or other physical means. For example, useful labels include ‘P. fluorescent dyes, electron-dense reagents, enzymes (e.g., as commonly used in an ELISA), biotin, digoxigenin, or haptens and proteins that can be made detectable, e.g., by incorporating a radioactive component into the peptide or used to detect antibodies specifically reactive with the peptide. Typically, a detectable label is attached to a molecule (e.g., antibody) with defined binding characteristics (e.g., a polypeptide with a known binding specificity), so as to allow the presence of the molecule (and therefore its binding target) to be readily detectable.

As used herein, “gene product” refers to a immature or mature mRNA or peptide sequence that is transcribed or translated respectively ultimately from a nucleotide sequence that encodes a gene.

As used herein, “oak mulch” refers to oak material that have been processed by machine.

### Discussion

Described herein are compositions, methods, and kits for suppression of HLB and/or Ca. L. asiaticus (CLas) infection in a plant or citrus plant subject.

In embodiments according to the present disclosure, plants or citrus plants as described herein can be one or more of Citrus sinensis, Citrus reticulata, and Citrus excels. In embodiments according to the present disclosure, a citrus plant is a Duncan grapefruit, Washington navel orange, citron mandarin, or Cleopatra mandarin.

In embodiments, the citrus plants can be C. medica, C. aurantium, C. tangerine, C. ichangensis, C. limetta, C. unshiu, C. maxima, C. grandis, C. Paradisi, C. maxima, C. limon, C. japonica, C. glauca, C. bergamia, C. sinensis, C. reticulata, Poncirus trifoliate, or hybrids thereof.

Plants as described herein can be infected with HLB or at risk for HLB infection.

### Compositions

Described herein are compositions for suppression of HLB in citrus plants. Described herein are compositions for treating symptoms of HLB in citrus plants having or suspected of having HLB.

In embodiments according to the present disclosure, described herein are aqueous oak leaf compositions. In embodiments according to the present disclosure, described herein are aqueous oak leaf compositions extracted from one or more processed oak leaves.

In an embodiment, described herein is an aqueous oak leaf extract composition extracted from one or more processed leaves of Quercus hemisphaerica. In embodiments, described herein are oak mulches, for example from Quercus hemisphaerica.

In additional embodiments, oak extracts and mulches can be from Black Oak (Quercus velutina). Black oaks can have trunk diameters between 3 and 4 feet and reach as high as 85 feet.

In additional embodiments, oak extracts and mulches can be from Bluejack Oak (Quercus marilandica). Small but strong, blackjack oaks typically don't grow higher than 50 feet; usually, they're between 20 and 30 feet when they're growing in North Florida.

In additional embodiments, oak extracts and mulches can be from Bluff Oak (Quercus austrina). Bluff oaks are typically found on riverside bluffs in fertile, moist soils. This oak produces oval-shaped acorns, unlike other acorns that you'll see in the North Florida timberlands.

In additional embodiments, oak extracts and mulches can be from Chapman Oak (Quercus chapmanii). Chapman oak trees can grow up to 50 feet high and have diameters of more than 12 inches, and they don't usually get that large in Florida.

In additional embodiments, oak extracts and mulches can be from Chinkapin Oak (Quercus muehlenbergii). Chinkapin oak trees are not usually found on the coastal plains, but inland, they're very good at reaching heights between 60 and 80 feet with 36-inch diameters.

In additional embodiments, oak extracts and mulches can be from Grand Oak (Guercus). The Grand oak tree is one of the largest and oldest specimens of its kind in Tampa Bay. It is also one of the hardiest and sturdiest trees of its species. The trunk can measure at least 34 inches diameter.

In additional embodiments, oak extracts and mulches can be from Laurel Oak (Quercus laurifolia). Typically growing up to 60 feet, laurel oaks are usually very thick—they generally have trunk diameters of 3 to 4 feet.

In additional embodiments, oak extracts and mulches can be from Live Oak (Quercus virginiana). Live oak trees tend to grow to heights of 40 to 50 feet. The live oak is ideal for timber due to their massive trunk diameters which sometimes reaches 48 inches across. Because they retain their leaves until after the following year's leaves appear, they're considered “evergreen.”

In additional embodiments, oak extracts and mulches can be from Myrtle Oak (Quercus myrtifolia). Myrtle oak trees are common along seashores, where they rarely grow over 35 feet with a trunk diameter of 4 to 8 inches. This oak is an evergreen shrub or tree that slowly grows.

In additional embodiments, oak extracts and mulches can be from Overcup Oak (Quercus lyata). Overcup oaks can grow up to heights of 100 feet, but in Florida, they're typically much shorter.

In additional embodiments, oak extracts and mulches can be from Post Oak (Quercus stellate). Post oak trees can grow up to 50 feet high, but they're typically more squat when they grow in Florida; they do best on dry, sandy soils and on rocky slopes, although they also appear in rich bottomlands.

In additional embodiments, oak extracts and mulches can be from Shumard Oak (Quercus shumardii). Shumard oaks are large and beautiful. They can reach up to 125 feet in height. It does best in deep, rich bottomlands near streams and on riverbanks.

In additional embodiments, oak extracts and mulches can be from Southern Red Oak (Quercus falcate). Southern red oak trees can grow as tall as 70 to 80 feet, and they typically have trunk diameters of 2 to 3 feet. They're exceptionally well-suited to dry, infertile soil.

In additional embodiments, oak extracts and mulches can be from Swamp Chestnut Oak (Quercus michauxii). Growing up to 80 feet, the swamp chestnut oak grows well in moist, bottomland soils that are periodically flooded in North Florida.

In additional embodiments, oak extracts and mulches can be from Turkey Oak (Quercus laevis). Turkey oak trees grow up to reach approximately 30 to 40 feet with thin trunk diameters which are rather small.

In additional embodiments, oak extracts and mulches can be from Water Oak (Quercus nigra). Water oak trees are tall but slim, reaching 50 to 70 feet with an average diameter of 2 to 3 feet.

In additional embodiments, oak extracts and mulches can be from White Oak (Quercus alba). White oaks, which are ideal for timber, typically grow between 60 and 70 feet in height.

In additional embodiments, oak extracts and mulches can be from Willow Oak (Quercus phellos). Willow oaks are some of the most enormous oaks in Florida and can reach between 80 and 130 feet when fully mature. Trunks are generally between 3 and 6 feet thick, and they do well on rich, moist bottomlands along swamps or near streams.

In certain aspects according to the present disclosure, compositions as described herein are extracted from processed leaves. In an embodiment, an amount of 200 g of fresh oak leaves can be collected for processing.

In an embodiment according to the present disclosure, leaves are processed according to the following method. In an embodiment, a composition as described herein is obtained by the following method: an amount of 200 g of fresh oak leaves was collected from Quercus hemisphaerica Bartram ex Willd (identified by the University of Florida Herbarium) and immediately processed. After collection, leaves were rinsed thoroughly (3 times) with running tap water and washed with sterile water. They were then ground into a fine powder by an electric blender (Ninja Professional Countertop Blender, SharkNinja Operating, LLC, Auburn, Ala., USA). In further embodiments, oak leaves can be processed by steam explosion.

In certain aspects of the present disclosure, compositions are extracted from processed leaves. In an embodiment, compositions can be extracted from processed leaves with water. In an embodiment, compositions can be extracted from processed leaves with an alcohol, for example ethanol or methanol. In further embodiments of the present disclosure, compositions as described herein can be delivered through oak mulch.

In an embodiment, the composition can be extracted from processed leaves by suspending the processed leaves in a 4-L flask containing 2 L of distilled water. The flask can vigorous shaken overnight at 28° C. The next day, the homogenate can be filtered through four layers of cheesecloth.

In certain aspects, the composition can be an effective amount to suppress citrus huanglongbing (HLB) in a subject. In an embodiment, an effective amount to suppress HLB in can be a biweekly application as a foliar spray and soil drench for two months. In an embodiment, oak mulch can be applied to citrus plants directed or to the soil around citrus plants.

In embodiments according to the present disclosure, the oak leaf extract comprises one or more of conjugated p-coumaric, ferulic, caffeic, hydroxycinnamic acids, catechins, and derivatives thereof. Without intending to be limiting, compounds of oak leaf extracts, including one or more of p-coumaric, ferulic, caffeic, hydroxycinnamic acids, catechins, and derivatives thereof, may have particular suitability in compositions for suppression of HLB.

### Methods

In an embodiment, a further aspect of the present disclosure encompasses methods of suppression of HLB in a subject. In an embodiment, a further aspect of the present disclosure encompasses treatment of symptoms of HLB in a subject having or suspected of having HLB. Methods of suppression of HLB (or treating symptoms of HLB) in a subject as described herein comprise administering a composition as described herein to a subject in need thereof.

In an embodiment, described herein is a method for suppressing of citrus huanglongbing (HLB) in a subject in need thereof, comprising providing a composition as described herein to the subject in need thereof. In an embodiment, described herein is a method for treatment of symptoms of citrus huanglongbing (HLB) in a subject in need thereof, comprising providing a composition as described herein to the subject in need thereof. The subject in need thereof can be a plant as described herein having or suspected of having HLB.

According to embodiments of the present disclosure, the composition can be applied to the subject through irrigation, spray, or both.

In embodiments of methods as described herein, the irrigation can be irrigation to the soil of the plants through a hose or sprinkler. The soil can be soil surrounding a trunk of a tree and/or soil in which at least one root of the tree/plant is present.

In embodiments, the spraying can be with a handheld applicator, such as a spray bottle, or other larger-scale non-handheld device.

In an embodiment, the composition is applied to the subject in need thereof biweekly application as a foliar spray and soil drench for two months. In an embodiment, processed oak mulch can be applied to or the soil around citrus plants.

According to methods as described herein, the composition can be applied to the roots, the leaves, or both.

The subject in need thereof can be a citrus plant infected with HLB.

In embodiments of the methods as described herein, the composition can be an effective amount to suppress HLB in the subject in need thereof.

### Kits

Also disclosed herein are kits comprising a composition as described herein.

A kit can further comprise an application device, for example a plastic spray bottle.

Described herein are methods of using kits as described herein. Methods of use can comprise assembling the kit from the components thereof and administering the composition of the kit to a subject in need thereof.

While embodiments of the present disclosure are described in connection with the Examples and the corresponding text and figures, there is no intent to limit the disclosure to the embodiments in these descriptions. On the contrary, the intent is to cover all alternatives, modifications, and equivalents included within the spirit and scope of embodiments of the present disclosure.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

Abstract

Citrus greening, also called Huanglongbing (HLB), is one of the most destructive citrus diseases worldwide. It is caused by the fastidious gram-negative α-proteobacteria bacterium Candidatus Liberibacter asiaticus (CLas) and vectored by the Asian citrus psyllid (ACP), Diaphorina citri. Currently, there is no cure for HLB, no compounds have been successful in controlling HLB, and no sustainable management practices have been established for citrus greening disease. Thus, searching for alternative citrus greening disease mitigation strategies is considered an urgent priority for a sustainable citrus industry. An aim of present example is to use compounds extracted from oak, Quercus hemisphaerica, and to assess the antibacterial effects of these against CLas-infected citrus plants. The application of aqueous oak leaf extracts showed substantial inhibitory effects against CLas in citrus plants and the activity of genes related to starch. Significant differences were also observed in plant phenotypic and physiological traits after treatments. Citrus plants treated with oak extracts displayed an increase in stomatal conductance, chlorophyll content and nutrient uptake concurrently with a reduction of CLas titer, when compared to citrus plants treated with just water. The information provided from the present example comprises a new management treatment program to effectively deal with the HLB disease.

### Introduction

Huanglongbing (HLB; also known as citrus greening) is a bacterial disorder that is severely reducing global citrus production. HLB is widespread in most citrus areas of Asia, Africa, and the Americas [1, 2]. It is caused by a vector-transmitted, phloem-limited fastidious α-proteo-bacterium provisionally named Candidatus Liberibacter asiaticus (CLas) [2, 3]. The first symptoms usually do not appear for up to two years after initial infection, making early detection difficult and leaving infected trees in the orchard available for continued transmission by the Asian citrus psyllid (ACP) Diaphorina citri. Typical early symptoms are yellowing of isolated shoots, leaf loss, and fruit drop [4]. Fruit may be small, misshaped, lop-sided, and contain aborted seeds. Once symptoms appear, the tree will continue to decline over a period of 3-8 years and may not produce any marketable fruit during this period [5].

HLB in Florida was first detected in 2005 and is now widely distributed throughout the commercial citrus-growing regions; more than 80% of all citrus trees are infected [6]. The disease was recently identified in Texas, Arizona, and California [7]. There is no cure for HLB, and there are no commercial citrus cultivars, varieties, or scion-rootstock grafting combinations with natural resistance to CLas infection [8-13]. Current methods to control the spread of citrus greening are limited to aggressive ACP control and removal and destruction of infected trees [14]. The use of broad-spectrum insecticides for vector control is the primary method of managing the spread of the HLB pathogen. However, the convenience of pesticide sprays for ACP containment often generate concerns about chemical residues in fruit and juice and the likelihood of development of ACP resistance [15].

While pesticides control ACP, bactericides directly target the CLas. Currently available antibiotics include oxytetracycline and streptomycin [16]. Although these have provided some benefit, concerns exist over residues in fruit and juice and the use of classical antibiotics that may lead to development of resistance to these molecules [17]. Such chemotherapy strategies using these antibiotics have only been moderately/transiently effective in reducing CLas titer in infected citrus plants. Other disease eradication/management methods implemented in commercial groves include enhanced nutrition programs and soil/water pH modification [17]. Some improvements in crop performance were noted overall, but increased grove maintenance costs reduced profitability [14]. For example, grove maintenance (per acre) costs in Florida increased from $771 (2002-2003) to $1,597 (2010-2011) and $2,376 (2016-2017) [18, 19]. Also, declining yields continue to impact citrus infrastructures, leading to a loss of packinghouses and processing facilities.

Anecdotal reports from Florida growers (personal communications, 2015-2019) have claimed that citrus growing within the drip line of large oak trees have no to very minimal HLB symptoms, while citrus trees nearby but not under the oak tree drip line have severe symptoms. In the research reported herein, the antibacterial activity of an aqueous oak-leaf extract containing secondary metabolites was evaluated after application to the foliage and roots of CLas-infected citrus plants. A goal of the present example was to decrease the disease severity while contributing to the long-term sustainability and economic growth of the citrus industry. To achieve this main goal, the specific objectives were (i) to investigate the effect and efficacy of oak leaf extract using in vivo conditions against CLas and (ii) to exploit oak leaf extracts to enhance potential physiological responses in citrus plants. Finally, changes in CLas titer and leaf physiological and molecular parameters were measured to examine the oak-leaf extract effects on HLB symptomatic citrus plants.

### Materials and Methods

### Citrus Plant Growth and Development

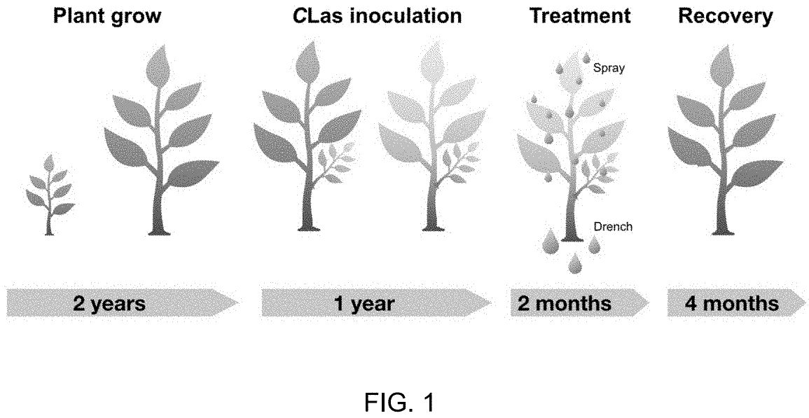

Plants (sweet oranges Citrus sinensis, ‘Valencia’) were grown in the screened US Horticultural Research Laboratory greenhouse in Fort Pierce, Fla., USA (Latitude 27.426741; Longitude −80.407557) using a routine horticultural practice. Promix BX (Premier Tech Horticulture, Quakertown, Pa., USA) potting soil was used. Fertilizer 20-10-20 (350 ppm N) was applied 1 time every 3 weeks. Temperature in the greenhouse was set to 25° C. during the day and 21° C. at night but could fluctuate to higher and lower temperatures depending on weather conditions. Plants were graft-inoculated via side-grafting with 3-4 cm CLas-positive Citrus sinensis “Valencia” bud sticks. Subsequently, three symptomatic CLas-infected citrus plants were supplied with aqueous oak extract, receiving biweekly applications for two months. For each treatment, 50 ml of the aqueous oak extract was foliar applied (spray), and 200 ml was drench applied (irrigation). Distillated water was applied to three CLas-infected plants as a control (FIG. 1).

### Harvesting

Six months after treatment applications, the plants were removed from their pots and all debris was rinsed off with DI water. Each plant was cut just above the roots, and the aboveground parts and roots were weighed separately on an analytical scale (Sartorius AG, Göttingen, Germany). Leaf lamina disks were placed in N,N-dimethylformamide (DMF) for chlorophyll analysis or placed in liquid nitrogen for gene expression analysis (see below). Once the samples were taken, the roots and aboveground plant parts were placed in separately labeled brown paper bags for dry weight measurements (described below).

### Aqueous Oak Leaf Extract

An amount of 200 g of fresh oak leaves was collected from Quercus hemisphaerica Bartram ex Willd. (identified by the University of Florida Herbarium) and immediately processed. After collection, leaves were rinsed thoroughly (3 times) with running tap water and washed with sterile water. They were then ground into a fine powder by an electric blender (Ninja Professional Countertop Blender, SharkNinja Operating, LLC, Auburn, Ala., USA). The processed leaves were then suspended in a 4-L flask containing 2 L of distilled water. The flask was vigorous shaken overnight at 28° C. The next day, the homogenate was filtered through four layers of cheesecloth and then applied biweekly as a foliar spray and soil drench for two months.

### Biochemical Characterization of Oak Bioactive Compound Extracts

To investigate and characterize the chemical composition of the oak crude extracts, fresh leaves of Q. hemisphaerica were liquified with a blender and subjected to extractions with either water or water and methanol (2:1; v/v). A 50 ml sample of each extract was concentrated close to dryness using a rotary evaporator. The concentrated oak leaf extracts were analyzed with a Waters 2695 Alliance high performance liquid chromatograph (HPLC) (Waters, Medford, Ma.) connected in parallel with a Waters 996 PDA detector and a Waters Micromass ZQ single-quadrupole mass spectrometer (MS) equipped with an electrospray ionization source. Compound separations were achieved with a Waters XBridge C8 analytical column (5 μm, 4.5×150 mm) with solvent conditions as previously reported [20]. A flow splitter (10:1) was used to simultaneously monitor UV and mass spectra of the eluting peaks. UV spectra were monitored between 400 to 240 nm.

### Plant Tissue Analysis

CLas-infected citrus trees treated with the oak extract and water control were analyzed to provide quantitative information about physiological responses and phenotypic plasticity in responses to the treatment. The titer of the bacterium was monitored using quantitative PCR (qPCR) with 16S rRNA gene-based specific primers during the study.

### Chlorophyll Contents

Chlorophyll a and b content were determined using DMF extraction and absorption correlation. Immediately after harvest, 100 mg of leaf lamina were cut from each plant, keeping the pieces relatively the same size and avoiding major leaf veins. The cut lamina was then placed in 25 ml of DMF and kept at 4° C. in the dark. Forty-eight hours later, the samples were tested in a UV-visible spectrophotometer (Thermoscientific Genesys 50, Hampton, N.H., USA) in quartz cuvettes at 664 and 647 nm. The resulting readings were then put into the following formulae [21]:

Chl a=12.64×A664−2.99×A647 (eq.1)

Chl b=−5.6×A664+23.26×A647 (eq.2)

### Stomatal Conductance

Stomatal conductance was measured at the end of the experiment. A steady state diffusion porometer was used (Decagon Devices model SC-1, Pullman, Wash., USA) to measure one leaf from the top, middle, and bottom of each plant at 12:00 pm (noon).

### Electrolyte Leakage

The procedure of the leakage test was modified from that described by Sanchez-Viveros, Gonzalez-Mendoza, Alarcon and Ferrera-Cerrato [22]. Leaf discs (100 g) were submerged in 50 ml of deionized water, and the initial conductivity C_{w} was measured (Thermo Scientific Orion ROSS Ultra pH/ATC Triode, Orion Star A325). Conductivity was measured again as C₀ after 3 hours of incubation at room temperature. The samples were then frozen overnight at −20° C. to release all the electrolytes. The final conductivity Cₜ was measured the next day once the samples reached room temperature. The percentage of electrolyte leakage was calculated:

EL=(C₀−C_{w})/(Cₜ−C_{w})×100 (eq. 3).

### Starch Detection and Accumulation

Enzymatic measurement of starch in leaves was performed using the manufacturer's protocol for the Enzychrom Assay Kit (Bioassay Systems, California US). Five leaf discs of 10 mg each were pulverized using liquid nitrogen. Starch content was determined using an enzymatic colorimetric method with the EnzyChrom Assay Kit. All samples were tested in triplicate, and the optical density values were measured at 585 nm.

### HLB Molecular Detection and Bacterial Titer Concentration

Leaves were collected 2, 3, and 6 months after the oak crude extract or water treatments were applied and then processed for total genomic DNA extraction followed by qPCR analysis. Total genomic DNA was extracted from citrus leaves using the following protocol. Two leaves from each tree were sampled. A razor blade was used to remove and process the midribs and placed in a BIOREBA (Reinach BL, Switzerland) extraction bag with 1 ml of 1×TE buffer. The midribs were then grounded in BIOREBA bags using HOMEX (Reinach BL, Switzerland) homogenizer. The resulting homogenate was used in a phenol extraction for DNA. 100 ng of DNA was used for qPCR analyses. Ct values corresponding to CLas titer were used to confirm that plants were CLas-infected before and after the treatments. To determine the CLas bacterium titer, leaves were collected and tested using SYBR® Green (Applied Biosystems, Foster City, Calif., USA) qPCR 16S rDNA primers LasLong [23]. SYBR Green qPCR amplifications were performed in a LightCycler 96 qPCR machine. LasLong primers were used for CLas detection, and CitrusDehydrin (CD) [24, 25] was amplified and used to examine DNA quality and internal reference for normalization using delta cycle threshold (ΔCt).

### Mineral Content Analysis

Approximately 1.5 g of dry plant material were used for mineral content analysis. Tissue nitrogen (N) concentration (%) was determined using a NA2500 carbon (C)/N Analyzer (Thermoquest CE Instruments; ThermoQuest Corporation, Thermo Fisher Scientific Inc., Waltham, Mass., USA). Tissue phosphorus (P) and potassium (K) concentrations were determined with the dry ash combustion digestion method [26]. A 1.5 g sample of dried plant material was weighed and dry ashed at 500° C. for 16 h. The ash was equilibrated with 15 ml of 0.5 M hydrochloric acid (HCl) at room temperature for 0.5 h. The solution was decanted into 15 ml plastic disposable tubes and placed in a refrigerator at 4° C. [27] until analyses by inductively coupled plasma atomic emission spectrometry (ICP-AES).

### Statistical Analyses and Experimental Design

Data were subjected to statistical analysis using Student's t-test (p=0.05). Minitab 17 Statistical Software (Minitab Inc., State College, Pa.) was used for the data analyses and interpretation. The relative gene expression data were analyzed using the 2^{-ΔΔCt} method as previously described [26].

### Results

### Oak Crude Extract Treatments Reduce HLB Symptoms and CLas Titer

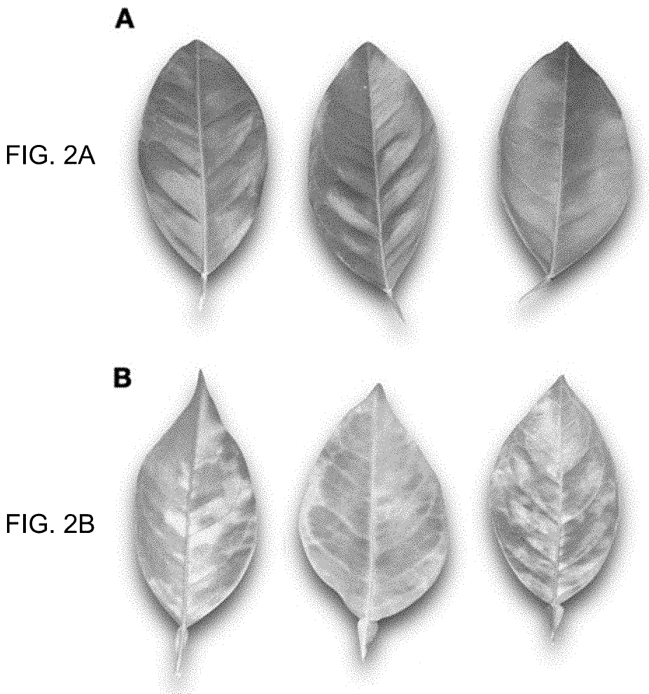

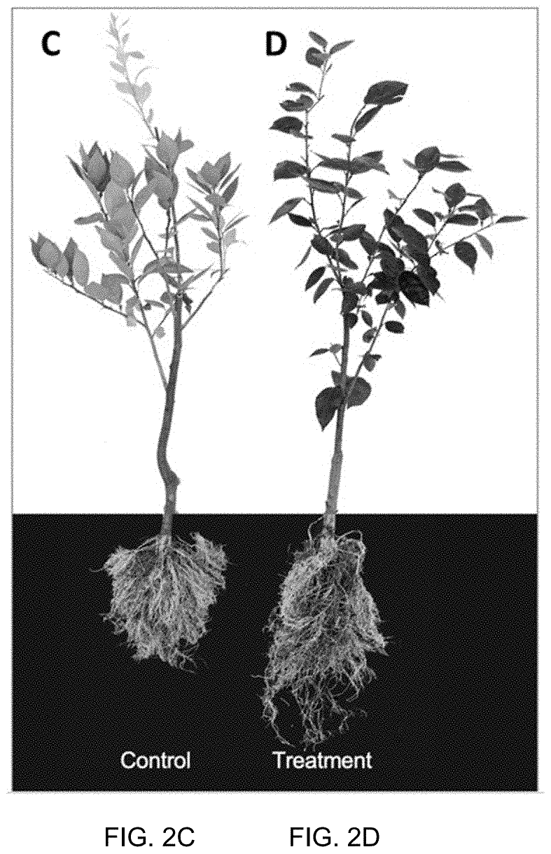

Typical symptoms of HLB on leaves include an asymmetrical chlorosis referred to as “blotchy mottle”. The yellowing leaf mottle symptoms of HLB-affected leaves are believed to result from the disintegration of the chloroplast thylakoid system caused by the bulky starch build-up; as the disease severity increases, disease symptoms become more visible [29-32]. Following the treatment with foliar spray and drench applications with oak extract, leaf yellowing was reduced (FIGS. 2A-2B). Interestingly, spray and drench treatment applications on CLas-infected citrus stimulated root growth and development (FIGS. 2C-2D). Oak extract reduced CLas titer in citrus trees using the oak extract after both drench and spray treatments (Table 1).
Table 1. Changes in Ct values of HLB-affected citrus trees after oak extract and water treatments. Ct values were determinate as described using LasLong (LL) primers as described on the table. Three trees (a-, b- and c-) from each treatment (Oak vs. Water) were used (n=3). Initial titer and internal control CD were used to normalize the results. After six months, the variation on CT value was calculated using Δ Ct value from time 0 and Δ Ct value after six months.

TABLE 1

| | time 0 | | | 6 months | | | |
|---|---|---|---|---|---|---|---|
| Treatment | Ct value LL | Ct value CD | Δ ALL CD | Ct value LL | Ct value CD | Δ LL CD | Ct variation |
| a-Oak | 27.3 | 21.5 | 5.7 | 27.5 | 20.5 | 6.9 | −1.2 |
| b-Oak | 24 | 20.3 | 3.7 | Not detected | 20.8 | N/A | N/A |
| c-Oak | 27.6 | 21.6 | 6 | 30 | 20.3 | 9.7 | −3.6 |
| a-Water | 25.9 | 21.5 | 4.5 | 26 | 21.5 | 4.5 | 0 |
| b-Water | 30.1 | 21.6 | 8.5 | 29.2 | 20.8 | 8.4 | 0.1 |
| c-Water | 30.8 | 21 | 9.8 | 24.9 | 21.2 | 3.7 | 6.1 |

### Nutrients (Macronutrient)

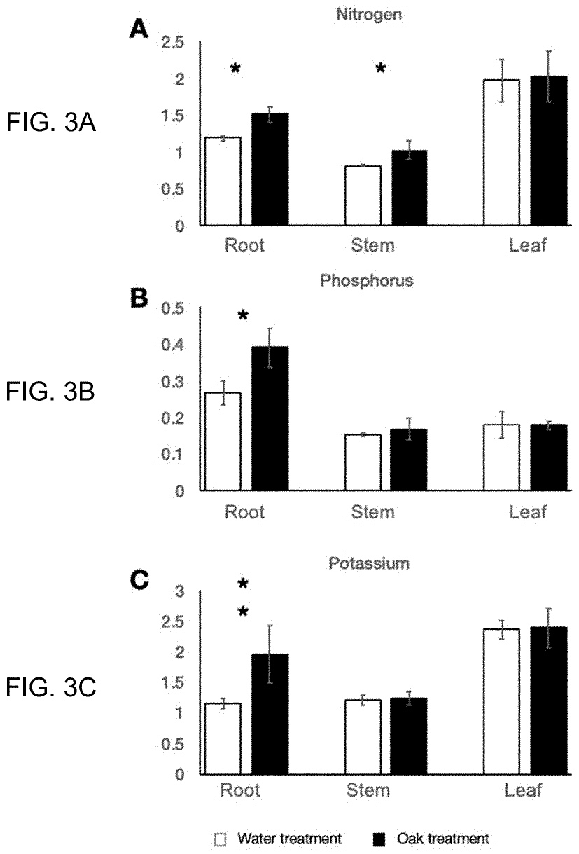

Oak leaf extract treatments significantly increased root nutrient uptake. A general trend in N, P, and K (%) showed a consistent and significant increase in the concentrations of these elements in roots (FIGS. 3A-3C). Root uptake increased by 21% for N, 31% for P, and 40% for K compared to the control. No statistically significant differences were detected in the leaves, but N was significantly higher in stems subjected to the oak extract treatment.

### Chlorophyll a and b Level Increased After Oak Treatment

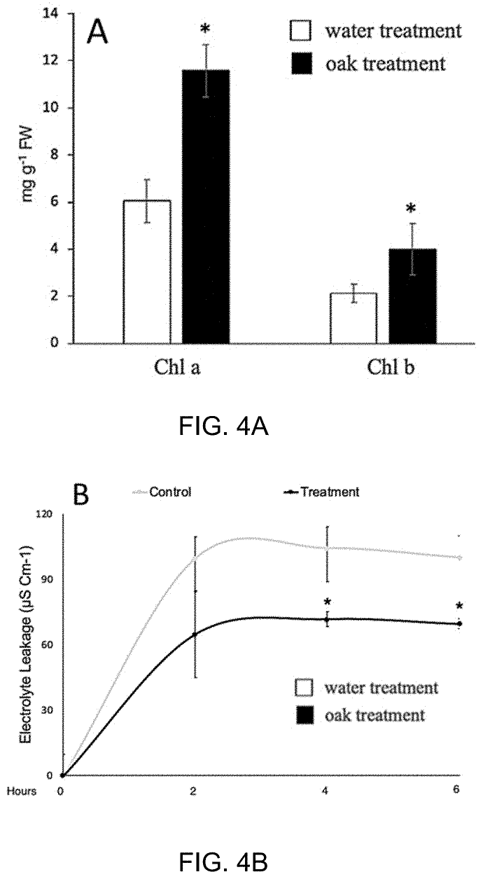

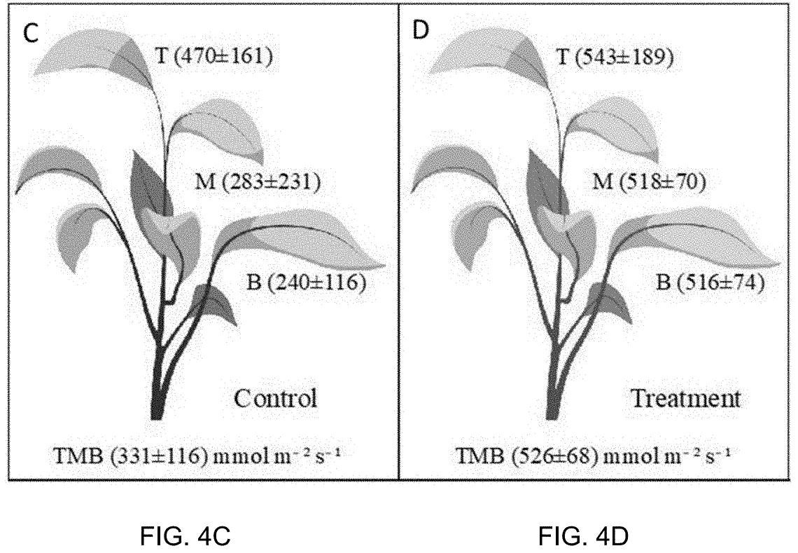

Chlorophyll production and activity are influenced by mineral nutrition and chemical metabolites produced in the plant system. HLB symptom development is associated with increased excitation pressure at PSII centers, followed by oxidative damage and irreversible destruction of centers, which leads to loss of chlorophyll, structural and nonstructural protein, and chlorosis [33, 34]. Chlorophyll a and b content was statistically significantly higher (+96% and +98%, respectively) in the plants treated with oak extract compared to the control (FIG. 4A), indicating enhanced photosynthetic capacity of treated plants.

### Cell Membrane Damage Decreases After Oak Extract Treatment

Electrolyte leakage is a classical method to estimate membrane integrity in response to environmental stresses. Electrolytes are contained within the membranes of plant cells. As the cells are subjected to stress, electrolytes leak into surrounding tissue [35, 36]. Ion leakage assays were performed for each treatment. Infected plants treated with water only had statistically significantly higher electrolyte leakage compared to the oak extract treatment (FIG. 4B). Leakage was lower by 35%, 31%, and 30% at 2, 4, and 8 h, respectively, after treatment application. Previous studies showed that HLB-affected citrus plants have increased K concentration compared to healthy plants, as pathogen-mediated disruption of membrane permeability could lead to electrolyte leakage [37].

### Stomatal Conductance Increases After Oak Extract Treatment

Stomatal conductance is a measure of the degree of stomatal opening and can be used as an indicator of plant water status. Responses of plant leaf stomatal conductance and photosynthesis to water deficit have been extensively reported [38, 39] [40-42]. Leaves from oak extract treatments had significantly higher (37%) stomatal conductance compared to the control, suggesting enhanced root growth and root system development (FIGS. 4C-4D).

### Starch Accumulation Decreases After Oak Extract Treatment

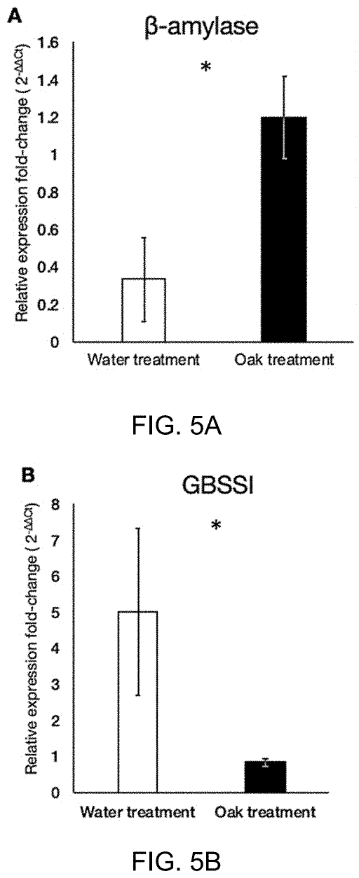

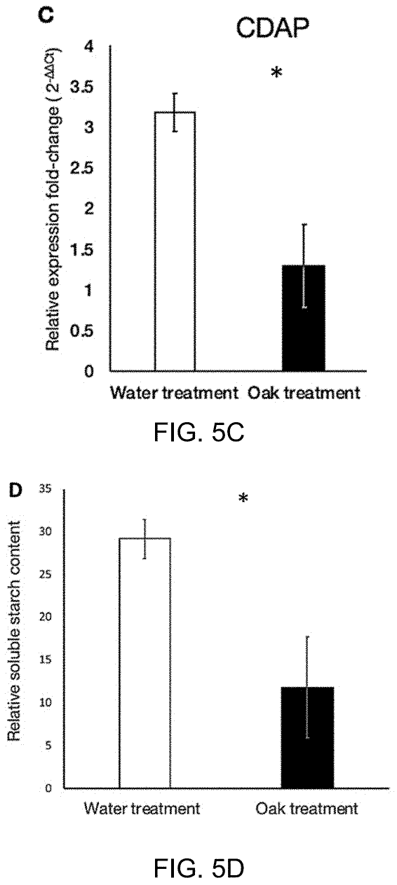

One of the most important HLB symptoms is leaf chlorosis caused by the abnormal accumulation of starch that leads to chloroplast disruption [30-32, 43, 44]. Transcriptomic and proteomic studies revealed that enzymes related to starch synthesis and degradation are regulated differently in response to CLas infection [45, 46]. We analyzed transcript expression level of starch synthesis and degradation related genes in plants of both treatments were analyzed, and differential expression levels were detected. β-amylase was enriched in extract-treated plants compared to control plants. β-amylase catalyzes the hydrolysis of starch into sugars and contributes to a reduction of starch content in leaves (3.6 folds reduction), thereby preventing chloroplast cell disruption (FIG. 5A) that consequently reduces typical HLB symptoms.

An enzyme involved in the synthesis of starch, granule bond starch synthase (GBSSI), was upregulated in the control plants (5-fold increase) but normally regulated in the plants treated with oak extract (FIG. 5B). A putative cell death associated protein (CDAP), which was shown to be upregulated in CLas-infected plants (2.5-fold increase) [47] was normally regulated in the oak extract treated plants (FIG. 5C). In accordance with these results, the starch concentration in the citrus plants treated with oak extract was 58% lower than in the control plants (FIG. 5D). These data suggest that the oak extract treatment reverses the effect of CLas and its ability to manipulate carbohydrate metabolism by altering the expression of a key gene for starch synthesis and degradation and preventing the disruption of chloroplast cells.

### Chemical Analysis of Oak Leaf Extracts

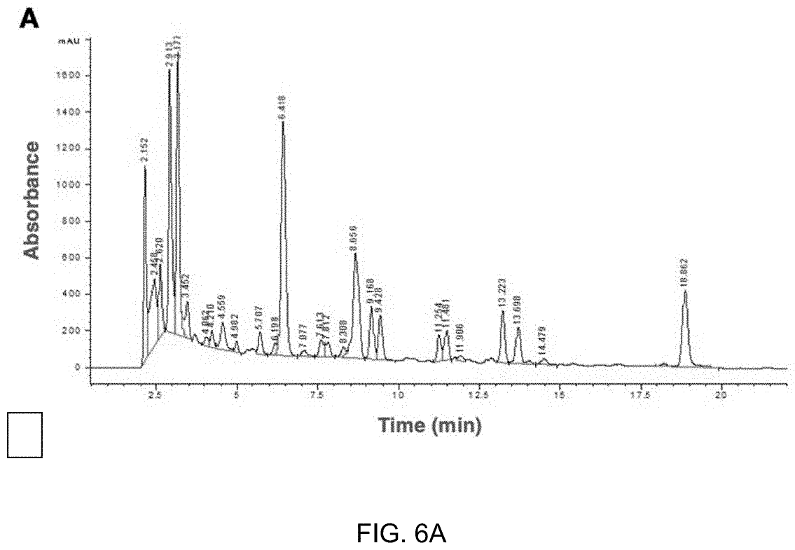

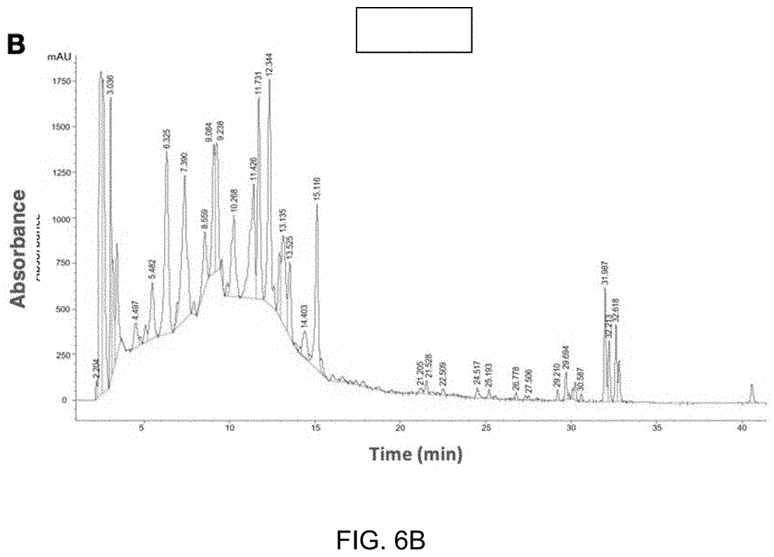

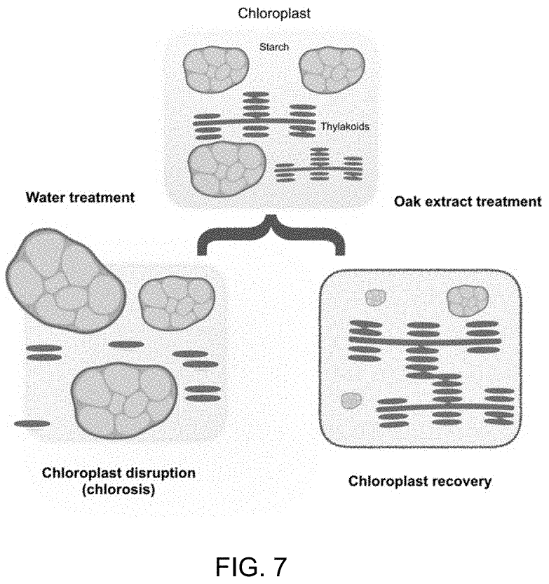

Preliminary HPLC-UV-MS analyses of the aqueous oak leaf extract indicate that hydroxycinnamates are the major water-soluble chemical constituents (FIGS. 6A-6B). The main peaks in the HPLC chromatograms all exhibited UV spectra indicative of the presence of conjugated hydroxycinnamic acids, ferulic, p-coumaric, and caffeic acids [48]. In a similar manner, results of the HPLC-MS analysis of the compounds in the oak leaf water extract showed prominent compound fragment ions at 193, and 163 and 147 m/z (data not shown), all of which are similar to their respective hydroxycinnamic acids. This was observed for nearly all the compounds detected in the oak leaf water extract. In sharp contrast, the oak leaf extract prepared with methanol/water (1/2, (v/v) contained many additional UV-absorbing compounds with absorbance wavelength maxima between 260 to 270 nm and spectra suggestive of catechins and proanthocyanidin complexes [49].

### Discussion

HLB constitutes a threat to global commercial and sustainable citrus production. All members of the Rutaceae family are susceptible to HLB, and there is no known cure for the disease, which severely reduces tree productivity and fruit quality and fosters tree decline and death. Since HLB disease is spread by psyllids, insecticidal control is recommended in commercial citrus to reduce incidence and severity of HLB [50]. However, it is well known that using chemical insecticides as the main control strategy is not sustainable and is known for its negative side effects such as environmental pollution, eruption of secondary pest outbreaks, and reduction of natural enemies. Although insecticides are considered effective at reducing psyllid populations, research indicates that even intensive insecticide programs are ineffective at preventing the spread of HLB [51, 52].

Alternative strategies focus on the identification of new potentially effective antimicrobial molecules against bacteria. During the past few decades, antimicrobial molecules were compromised, and the use of antibiotics has become less and less effective. The extensive use and misuses of agents against bacteria exacerbates high selective pressure on bacteria that develop antibiotic resistance. The decreasing effectiveness of antibiotics has pushed incentives for research of novel, effective, and affordable compounds.

Healthy citrus plants observed under natural conditions within ecological arboreal islands called hammocks were always located under oak tree drip canopy lines. Therefore, the present example was designed to identify the components of this ecological interaction that may protect citrus trees from HLB and become a commercial treatment for citrus growers. The use of plant extracts may hold greater promise for rapidly providing affordable treatment options. For this reason, a new scientific interest in biomolecules, identified from a natural source with antimicrobial activity, is currently in development. Secondary metabolites are extensively studied, and many examples of plant compounds have been used as controlling agents in both human and plant systems. A recent review of organic methods for combatting HLB mentions humic acids, microbial inoculants, protein hydrolysates, amino acids, and seaweed extracts as possible methods for managing bacterial infection [53]. Yet none of these methods can be used to cure the infected citrus trees. Other compounds including a group of newly discovered plant hormones known as homobrassinolides [54] and a molecule isolated from fungi known as radicinin [55] are also being investigated for their antimicrobial effects against CLas. While there are several examples in the literature studying the antibacterial effects of oak plant extracts against human pathogens [56-59] and for the allelopathic effects of these in plants [60, 61], to date there are no examples for the use of oak plant extracts for combatting HLB in citrus plants.

The present example is the first to show that the application of aqueous oak leaf extracts has a positive effect on HLB-affected citrus plants and can reduce HLB-related symptoms and CLas titer. Hydroxycinnamate and catechin derivatives as well as proanthocyanidin complexes observed in the preliminary HPLC-UV and MS analysis of the aqueous and aqueous methanol oak leaf extracts (FIGS. 5A-5B) are documented in the literature for their antibacterial activity [62-64]. The reason for the differences in compound classes observed in the aqueous oak leaf extract as compared to the aqueous methanol oak leaf extracts may be due to the increased solubility of plant solids in the latter [65]. Further analysis and compound identification are currently being pursued to identify further the compounds or compound classes associated with the positive effects observed in the aqueous oak leaf extract treated citrus trees in the present example.

Antibacterial activity in the aqueous oak extracts against CLas was identified and shown according to the present example. A reduction of CLas titer in treated citrus trees (Table 1) was shown along with no phytotoxic effects. Moreover, the present data show an overall significant recovery process that can contribute to minimization of typical HLB symptoms (FIGS. 2A-2D) in conjunction with CLas titer reduction that contributed to improve the physiological process. Physiological and molecular parameters on CLas-infected citrus was examined after oak crude extract treatments. Typical HLB symptoms were greatly reduced, these effects were consistent with the significant reduction in starch accumulation in the leaves and the different regulation of starch related genes (FIGS. 5A-5D). Massive starch accumulation in one of the most prominent symptoms of HLB infections, as excessive starch buildup causes disintegration of the chloroplast thylakoid system [46]. Furthermore, the induction of starch breakdown inside the chloroplast may contribute to increase of chlorophyll content, and improve stomatal conductance followed by an increased rate of photosynthesis and rapid recovery (FIGS. 4A-4D).

In HLB-infected leaves, several enzymes related to starch synthesis, degradation, and transport are differentially regulated in response to CLas infection. For example, the starch break-down machinery is repressed [32, 45, 46, 66-68]. It was found that the expression of enzymes involved in carbohydrate metabolism was restored by the treatment. For example, the β-amylase gene, involved in the degradation of starch to soluble sugars, was expressed to a greater degree in treated plants compared to CLas-infected plants treated with water (FIG. 5A). Another enzyme involved in the synthesis of starch, granule bond starch synthase, was upregulated in the CLas infected plants compared to the treated plants (FIG. 5B), which together with the suppression of starch degradation genes induces massive starch accumulation in the chloroplast [4, 30]. These results indicate that the carbohydrate metabolism was recovered after the oak extract treatment, and consequently both starch level and chlorosis decreased (FIG. 7). Also, a putative cell death associated protein (CX045772), a defense response and stress-related gene, was shown to be up regulated on HLB diseased citrus plants in both RT-qPCR and microarray analyses [30, 47], in the present example the treated citrus plants show a decrease of its expression compared to the control (FIG. 5C).

Additional, related, metabolic changes were measured, such as electrolyte leakage, which arises from membrane damage causing cell death as a direct consequence of extended damage due to stress [69-71]. Treated citrus plants reduced the electrolyte leakage in leaves (FIG. 4B), suggesting a reduction of stress caused by CLas. These intriguing observations indicate that the antibacterial property of the oak extract reduces CLas titer followed by a general reduction of all typical HLB symptoms.

To obtain further insights on the impact of oak leaf extracts on HLB-affected citrus plants, a series of physiological analysis was performed: i.e., stomatal conductance, chlorophyll content and macronutrient levels. Given that transpiration-driven water flow is required for nutrient and plant nutrient acquisition from the soil, stomatal conductance is tightly linked to water uptake by roots. In the present example the macronutrient level in roots, stems, and leaves was measured and an increase of all the macro elements was found in roots. Chlorophyll content was higher in plants treated with the oak extract (FIG. 4A). Root growth and the absorption of nutrients by roots together with higher stomata conductance resulted in increased macronutrient uptake accompanied by an increased content of chlorophyll.

In conclusion, aqueous extract from Q. hemisphaerica decreases CLas titer and improves the overall tree physiology of HLB-affected citrus. Importantly, HLB-affected citrus trees recovered after the treatment, indicating that the deleterious effects of CLas can be reversed with oak extract treatments. Overall, the information provided from the present example comprises compositions and methods related to the management and treatment for a novel control strategy and represents the first potential organic cure for growers to manage HLB more effectively.

### REFERENCES

[1] W. Li, L. Levy, J. S. Hartung, Quantitative Distribution of ‘Candidatus Liberibacter asiaticus’ in Citrus Plants with Citrus Huanglongbing, Phytopathology, 99 (2009) 139-144.
[2] Z. Zheng, J. Chen, X. Deng, Historical Perspectives, Management, and Current Research of Citrus HLB in Guangdong Province of China, Where the Disease has been Endemic for Over a Hundred Years, Phytopathology, 108 (2018) 1224-1236.
[3] T. R. Gottwald, Current Epidemiological Understanding of Citrus Huanglongbing, Annual Review of Phytopathology, 48 (2010) 119-139.
[4] V. Aritua, D. Achor, F. G. Gmitter, G. Albrigo, N. Wang, Transcriptional and Microscopic Analyses of Citrus Stem and Root Responses to Candidatus Liberibacter asiaticus Infection, Plos One, 8 (2013).
[5] S. E. Halbert, K. L. Manjunath, Asian citrus psyllids (Sternorrhyncha: Psyllidae) and greening disease of citrus: a literature review and assessment of risk in Florida, Florida Entomologist, 87 (2004) 330-353.
[6] J. H. Graham, E. G. Johnson, T. R. Gottwald, M. S. Irey, Presymptomatic Fibrous Root Decline in Citrus Trees Caused by Huanglongbing and Potential Interaction with Phytophthora spp, Plant Disease, 97 (2013) 1195-1199.
[7] N. Wang, P. Trivedi, Citrus huanglongbing: a newly relevant disease presents unprecedented challenges, Phytopathology, 103 (2013) 652-665.
[8] D. Teixeira, N. Wulff, E. Martins, E. Kitajima, R. Bassanezi, A. Ayres, S. Eveillard, C. Saillard, J. Bové, A phytoplasma closely related to the Pigeon Pea Witches'-Broom Phytoplasma (16Sr IX) is associated with citrus huanglongbing symptoms in the state of São Paulo, Brazil, Phytopathology, 98 (2008) 977-984.
[9] D. d. C. Teixeira, C. Saillard, S. Eveillard, J. L. Danet, P. I. da Costa, A. J. Ayres, J. Bové, ‘Candidatus Liberibacter americanus’, associated with citrus huanglongbing (greening disease) in São Paulo State, Brazil, Int J Syst Evol Microbiol, 55 (2005) 1857-1862.
[10] U. Albrecht, K. D. Bowman, Tolerance of trifoliate citrus rootstock hybrids to Candidatus Liberibacter asiaticus, Scientia Horticulturae, 147 (2012) 71-80.
[11] U. Albrecht, O. Fiehn, K. D. Bowman, Metabolic variations in different citrus rootstock cultivars associated with different responses to Huanglongbing, Plant Physiology and Biochemistry, 107 (2016) 33-44.
[12] U. Albrecht, G. McCollum, K. D. Bowman, Influence of rootstock variety on Huanglongbing disease development in field-grown sweet orange (Citrus sinensis [L.] Osbeck) trees, Scientia horticulturae, 138 (2012) 210-220.
[13] K. D. Bowman, G. McCollum, U. Albrecht, Performance of ‘Valencia’ orange (Citrus sinensis [L.] Osbeck) on 17 rootstocks in a trial severely affected by huanglongbing, Scientia Horticulturae, 201 (2016) 355-361.
[14] S. Alvarez, E. Rohrig, D. Solís, M. H. Thomas, Citrus Greening Disease (Huanglongbing) in Florida: Economic Impact, Management and the Potential for Biological Control, Agricultural Research, 5 (2016) 109-118.
[15] X. D. Chen, T. A. Gill, K. S. Pelz-Stelinski, L. L. Stelinski, Risk assessment of various insecticides used for management of Asian citrus psyllid, Diaphorina citri in Florida citrus, against honey bee, Apis mellifera, Ecotoxicology, 26 (2017) 351-359.
[16] M. Zhang, Y. Guo, C. A. Powell, M. S. Doud, C. Yang, Y. Duan, Effective Antibiotics against ‘Candidatus Liberibacter asiaticus’ in HLB-Affected Citrus Plants Identified via the Graft-Based Evaluation, PLOS ONE, 9 (2014) e111032.
[17] D. R. Boina, J. R. Bloomquist, Chemical control of the Asian citrus psyllid and of huanglongbing disease in citrus, Pest Management Science, 71 (2015) 808-823.
[18] S. A. Schumann A, The economics of citrus undercover production systems and whole tree thermotherapy, Citrus Ind, 14 (2016).
[19] A. Singerman, M. Burani-Arouca, S. H. Futch, The Profitability of New Citrus Plantings in Florida in the Era of Huanglongbing, HortScience, 53 (2018) 1655-1663.
[20] F. Hijaz, Y. Nehela, S. E. Jones, M. Dutt, J. W. Grosser, J. A. Manthey, N. Killiny, Metabolically engineered anthocyanin-producing lime provides additional nutritional value and antioxidant potential to juice, Plant Biotechnology Reports, 12 (2018) 329-346.
[21] R. Moran, Formulae for Determination of Chlorophyllous Pigments Extracted with <em>N,N</em>-Dimethylformamide, Plant Physiology, 69 (1982) 1376-1381.
[22] G. Sanchez-Viveros, D. Gonzalez-Mendoza, A. Alarcon, R. Ferrera-Cerrato, Copper effects on photosynthetic activity and membrane leakage of Azolla filiculoides and A. caroliniana, International Journal of Agriculture and Biology, 12 (2010) 365-368.
[23] G. Hao, E. Stover, G. Gupta, Overexpression of a Modified Plant Thionin Enhances Disease Resistance to Citrus Canker and Huanglongbing (HLB), Front Plant Sci, 7 (2016) 1078-1078.
[24] E. Stover, D. G. Hall, R. G. Shatters, G. A. Moore, Influence of Citrus Source and Test Genotypes on Inoculations with Candidatus Liberibacter asiaticus, 51 (2016) 805.
[25] R. Collier, K. Dasgupta, Y. P. Xing, B. T. Hernandez, M. Shao, D. Rohozinski, E. Kovak, J. Lin, M. L. P. de Oliveira, E. Stover, K. F. McCue, F. G. Harmon, A. Blechl, J. G. Thomson, R. Thilmony, Accurate measurement of transgene copy number in crop plants using droplet digital PCR, The Plant journal: for cell and molecular biology, 90 (2017) 1014-1025.
[26] D. L. Anderson, L. J. Henderson, Comparing sealed chamber digestion with other digestion methods used for plant tissue analysis, Agronomy journal, 80 (1988) 549-552.
[27] C. O. Plank, Plant analysis reference procedures for the southern region of the United States, South Coop Ser Bull, 368 (1992).
[28] K. J. Livak, T. D. Schmittgen, Analysis of relative gene expression data using real-time quantitative PCR and the 2(-Delta Delta C(T)) Method, Methods, 25 (2001) 402-408.
[29] A. A. Schaffer, K. C. Liu, E. E. Goldschmidt, C. D. Boyer, R. Goren, Citrus Leaf Chlorosis Induced by Sink Removal—Starch, Nitrogen, and Chloroplast Ultrastructure, J Plant Physiol, 124 (1986) 111-121.
[30] J. S. Kim, U. S. Sagaram, J. K. Burns, J. L. Li, N. Wang, Response of Sweet Orange (Citrus sinensis) to ‘Candidatus Liberibacter asiaticus’ Infection: Microscopy and Microarray Analyses, Phytopathology, 99 (2009) 50-57.
[31] D. C. Whitaker, M. C. Giurcanu, L. J. Young, P. Gonzalez, E. Etxeberria, P. Roberts, K. Hendricks, F. Roman, Starch Content of Citrus Leaves Permits Diagnosis of Huanglongbing in the Warm Season but Not Cool Season, Hortscience, 49 (2014) 757-762.
[32] M. Pitino, V. Allen, Y. Duan, LasDelta5315 Effector Induces Extreme Starch Accumulation and Chlorosis as Ca. Liberibacter asiaticus Infection in Nicotiana benthamiana, Front Plant Sci, 9 (2018) 113.
[33] N. R. Baker, J. Harbinson, D. M. Kramer, Determining the limitations and regulation of photosynthetic energy transduction in leaves, Plant Cell Environ, 30 (2007) 1107-1125.
[34] P. Horton, A. Ruban, Molecular design of the photosystem II light-harvesting antenna: photosynthesis and photoprotection, J Exp Bot, 56 (2005) 365-373.
[35] P. S. Campos, V. Quartin, J. C. Ramalho, M. A. Nunes, Electrolyte leakage and lipid degradation account for cold sensitivity in leaves of Coffea sp. plants, J Plant Physiol, 160 (2003) 283-292.
[36] K. Kocheva, P. Lambrev, G. Georgiev, V. Goltsev, M. Karabaliev, Evaluation of chlorophyll fluorescence and membrane injury in the leaves of barley cultivars under osmotic stress, Bioelectrochemistry, 63 (2004) 121-124.
[37] C. C. Nwugo, Y. Duan, H. Lin, Study on citrus response to huanglongbing highlights a down-regulation of defense-related proteins in lemon plants upon ‘Ca. Liberibacter asiaticus’ infection, Plos One, 8 (2013) e67442.
[38] Q. Jiang, D. Roche, T. A. Monaco, D. Hole, Stomatal conductance is a key parameter to assess limitations to photosynthesis and growth potential in barley genotypes, Plant Biol (Stuttg), 8 (2006) 515-521.
[39] T. L. Hennessey, C. B. Field, Circadian Rhythms in Photosynthesis: Oscillations in Carbon Assimilation and Stomatal Conductance under Constant Conditions, Plant Physiol, 96 (1991) 831-836.
[40] H. Tewolde, A. K. Dobrenz, R. L. Voigt, Seasonal trends in leaf photosynthesis and stomatal conductance of drought stressed and nonstressed pearl millet as associated to vapor pressure deficit, Photosynth Res, 38 (1993) 41-49.
[41] J. Urban, M. W. Ingwers, M. A. McGuire, R. O. Teskey, Increase in leaf temperature opens stomata and decouples net photosynthesis from stomatal conductance in Pinus taeda and Populus deltoidesx nigra, J Exp Bot, 68 (2017) 1757-1767.
[42] J. Gago, M. Daloso Dde, C. M. Figueroa, J. Flexas, A. R. Fernie, Z. Nikoloski, Relationships of Leaf Net Photosynthesis, Stomatal Conductance, and Mesophyll Conductance to Primary Metabolism: A Multispecies Meta-Analysis Approach, Plant Physiol, 171 (2016) 265-279.
[43] E. Etxeberria, P. Gonzalez, D. Achor, G. Albrigo, Anatomical distribution of abnormally high levels of starch in HLB-affected Valencia orange trees, Physiol Mol Plant P, 74 (2009) 76-83.
[44] G. Yelenosky, C. L. Guy, Carbohydrate Accumulation in Leaves and Stems of Valencia Orange at Progressively Colder Temperatures, Bot Gaz, 138 (1977) 13-17.
[45] F. Martinelli, S. L. Uratsu, U. Albrecht, R. L. Reagan, M. L. Phu, M. Britton, V. Buffalo, J. Fass, E. Leicht, W. X. Zhao, D. W. Lin, R. D'Souza, C. E. Davis, K. D. Bowman, A. M. Dandekar, Transcriptome Profiling of Citrus Fruit Response to Huanglongbing Disease, Plos One, 7 (2012).
[46] J. Fan, C. Chen, R. H. Brlansky, F. G. Gmitter, Z. G. Li, Changes in carbohydrate metabolism in Citrus sinensis infected with ‘Candidatus Liberibacter asiaticus’, Plant Pathol, 59 (2010) 1037-1043.
[47] M. X. M. L. J. C. Y. X. Z. Z. Q. Z. X. Deng, Preliminary research on soil conditioner mediated citrus Huanglongbing mitigation in the field in Guangdong, China, Eur J Plant Pathol, 137 (2013) 283-293.
[48] M. L. Bengoechea, A. I. Sancho, B. Bartolomé, I. Estrella, C. Gómez-Cordovés, M. T. Hernández, Phenolic composition of industrially manufactured purees and concentrates from peach and apple fruits, Journal of Agricultural and Food Chemistry, 45 (1997) 4071-4075.
[49] Y. Nakamura, S. Tsuji, Y. Tonogai, Analysis of proanthocyanidins in grape seed extracts, health foods and grape seed oils, Journal of health science, 49 (2003) 45-54.
[50] J. A. Qureshi, B. C. Kostyk, P. A. Stansly, Insecticidal suppression of Asian citrus psyllid Diaphorina citri (Hemiptera: Liviidae) vector of huanglongbing pathogens, Plos One, 9 (2014) e112331.
[51] D. G. Hall, M. L. Richardson, E. D. Ammar, S. E. Halbert, Asian citrus psyllid, Diaphorina citri, vector of citrus huanglongbing disease, Entomol Exp Appl, 146 (2013) 207-223.
[52] S. Tiwari, L. L. Stelinski, M. E. Rogers, Biochemical basis of organophosphate and carbamate resistance in Asian citrus psyllid, J Econ Entomol, 105 (2012) 540-548.
[53] E. F. Cochrane, J. B. Shade, Combatting Huanglongbing in Organic Systems, International journal of Horticulture, Agriculture and Food science (IJHAF) 3(2019) 1-11.
[54] F. Alferez, C. Vincent, T. Vashisth, Effects of Homobrassinolides on HLB-Affected Trees in Florida, Citrus Industry, October 2018 (2018) 19-21.
[55] C. Brandenburg, J. Lockner, K. Maloney, C. Castro, A. Blacutt, C. Roper, P. Rolshausen, Toward the synthesis of radicinin, an inhibitor of Pierce's disease and citrus greening disease, in: Abstracts of Papers of the American Chemical Society, Amer Chemical Soc 1155 16th St, NW, Washington, DC 20036 USA, 2019.
[56] M. Gulluce, F. Sahin, M. Sokmen, H. Ozer, D. Daferera, A. Sokmen, M. Polissiou, A. Adiguzel, H. Ozkan, Antimicrobial and antioxidant properties of the essential oils and methanol extract from Mentha longifolia L. ssp. longifolia, Food chemistry, 103 (2007) 1449-1456.
[57] S. M. Seyyednejad, H. Motamedi, A review on native medicinal plants in Khuzestan, Iran with antibacterial properties, International journal of Pharmacology, 6 (2010) 551-560.
[58] N. Y. Sariozlu, M. Kivanc, Gallnuts (Quercus infectoria Oliv. and Rhus chinensis Mill.) and their usage in health, in: Nuts and seeds in health and disease prevention, Elsevier, 2011, pp. 505-511.
[59] S. T. Kim, R. Cristescu, A. J. Bass, K.-M. Kim, J. I. Odegaard, K. Kim, X. Q. Liu, X. Sher, H. Jung, M. Lee, Comprehensive molecular characterization of clinical responses to PD-1 inhibition in metastatic gastric cancer, Nature medicine, 24 (2018) 1449.
[60] B. Rathinasabapathi, J. Ferguson, M. Gal, Evaluation of allelopathic potential of wood chips for weed suppression in horticultural production systems, Hortscience, 40 (2005) 711-713.
[61] A. Águas, G. Incerti, A. Saracino, V. Lanzotti, J. S. Silva, F. C. Rego, S. Mazzoleni, G. Bonanomi, Fire effects on litter chemistry and early development of Eucalyptus globulus, Plant and soil, 422 (2018) 495-514.
[62] S. Hemaiswarya, M. Doble, Synergistic interaction of phenylpropanoids with antibiotics against bacteria, Journal of Medical Microbiology, 59 (2010) 1469-1476.
[63] R. Veluri, T. L. Weir, H. P. Bais, F. R. Stermitz, J. M. Vivanco, Phytotoxic and antimicrobial activities of catechin derivatives, Journal of Agricultural and Food Chemistry, 52 (2004) 1077-1082.
[64] R. Mayer, G. Stecher, R. Wuerzner, R. C. Silva, T. Sultana, L. Trojer, I. Feuerstein, C. Krieg, G. Abel, M. Popp, Proanthocyanidins: target compounds as antibacterial agents, Journal of agricultural and food Chemistry, 56 (2008) 6959-6966.
[65] T. V. Ngo, C. J. Scarlett, M. C. Bowyer, P. D. Ngo, Q. V. Vuong, Impact of different extraction solvents on bioactive compounds and antioxidant capacity from the root of Salacia chinensis L, Journal of Food Quality, 2017 (2017).
[66] U. Albrecht, K. D. Bowman, Gene expression in Citrus sinensis (L.) Osbeck following infection with the bacterial pathogen Candidatus Liberibacter asiaticus causing Huanglongbing in Florida, Plant Science, 175 (2008) 291-306.
[67] C. C. Nwugo, Y. P. Duan, H. Lin, Study on Citrus Response to Huanglongbing Highlights a Down-Regulation of Defense-Related Proteins in Lemon Plants Upon ‘Ca. Liberibacter asiaticus’ Infection, Plos One, 8 (2013).
[68] M. R. Xu, Y. Li, Z. Zheng, Z. H. Dai, Y. Tao, X. L. Deng, Transcriptional Analyses of Mandarins Seriously Infected by ‘Candidatus Liberibacter asiaticus’, Plos One, 10 (2015).
[69] B. H. Lee, J. K. Zhu, Phenotypic analysis of Arabidopsis mutants: electrolyte leakage after freezing stress, Cold Spring Harb Protoc, 2010 (2010) pdb prot4970.
[70] V. Demidchik, D. Straltsova, S. S. Medvedev, G. A. Pozhvanov, A. Sokolik, V. Yurin, Stress-induced electrolyte leakage: the role of K+-permeable channels and involvement in programmed cell death and metabolic adjustment, J Exp Bot, 65 (2014) 1259-1270.
[71] S. Bai, J. Liu, C. Chang, L. Zhang, T. Maekawa, Q. Wang, W. Xiao, Y. Liu, J. Chai, F. L. Takken, P. Schulze-Lefert, Q. H. Shen, Structure-function analysis of barley NLR immune receptor MLA10 reveals its cell compartment specific activity in cell death and disease resistance, PLoS Pathog, 8 (2012) e1002752.

Unless defined otherwise, all technical and scientific terms used have the same meaning as commonly understood by one of ordinary skill in the art to which this disclosure belongs. Although any methods and materials similar or equivalent to those described can also be used in the practice or testing of the present disclosure, the preferred methods and materials are now described.

Embodiments of the present disclosure will employ, unless otherwise indicated, techniques of separating, testing, and constructing materials, which are within the skill of the art. Such techniques are explained fully in the literature.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

At least the following is claimed:

1) An aqueous oak leaf extract composition extracted from one or more processed leaves of Quercus hemisphaerica.

2) The aqueous oak leaf extract composition of claim 1, wherein the composition is extracted with water.

3) The aqueous oak leaf extract composition of claim 1, wherein the composition is extracted with ethanol or methanol.

4) The aqueous oak leaf extract composition of any one of claims 1 to 3 wherein the composition is an effective amount to suppress citrus huanglongbing (HLB) in a subject.

5) A method for suppressing of citrus huanglongbing (HLB) in a subject in need thereof, comprising:
providing a composition of claim 1 to the subject in need thereof.

6) The method of claim 5, wherein the composition is applied to the subject by irrigating, spraying, or both.

7) The method of claim 5, wherein the composition is applied biweekly for two months.

8) The method of claim 5, wherein the composition is applied to the roots, the leaves, or both.

9) The method of claim 5, wherein the subject in need thereof is a citrus plant infected with HLB.

10) The method of claim 5, wherein the subject in need thereof is one of Citrus medica, Citrus maxima, Citrus sinensis, Citrus reticulata, or Citrus excels.

11) The method of claim 9, wherein the citrus plant is a Duncan grapefruit, Washington navel orange, citron mandarin, or Cleopatra mandarin.

12) The method of claim 9, wherein the citrus plant is selected from the group consisting of individuals or hybrids of: C. medica, C. aurantium, C. tangerine, C. ichangensis, C. limetta, C. unshiu, C. maxima, C. grandis, C. Paradisi, C. maxima, C. limon, C. japonica, C. glauca, C. bergamia, C. sinensis, C. reticulata, Poncirus trifoliate, or hybrids thereof.

13) The method of claim 6, wherein the irrigating is to the soil of the subject.

14) The method of claim 6, wherein the spraying is to one or more leaves of the subject.

15) The method of claim 5, wherein the composition is an effective amount to suppress HLB in the subject in need thereof.

16) The method of claim 5, wherein the composition is present in processed oak mulch.

17) A kit for suppressing citrus huanglongbing (HLB) in a subject in need thereof, comprising a composition of claim 1.

18) The kit of claim 17, further comprising an application device.

19) The kit of claim 17, wherein the composition is in an amount effective to suppress citrus huanglongbing (HLB) in the subject in need thereof.
